(19) United States
(12) Patent Application Publication
(10) Pub. No.: US 2007/0195986 A1
(43) Pub. Date: Aug. 23, 2007

(54) Diaphragms for Loudspeaker Drive Units For Microphones

(75) Inventor: Gary Paul Geaves, Brighton (GB)

Correspondence Address: BUCHANAN, INGERSOLL & ROONEY PC, POST OFFICE BOX 1404, ALEXANDRIA, VA, 22313-1404, US

(73) Assignee: B & W LOUDSPEAKERS LIMITED, SUSSEX (GB)

(21) Appl. No.: 11/578,350

(22) PCT Filed: Mar. 3, 2005
(86) PCT No.: PCT/GB05/00809

§ 371 Date: Oct. 12, 2006

(30) Foreign Application Priority Data
Apr. 15, 2004 (GB) 0408458.8

(51) Int. Cl. H04R 9/06; H04R 11/02

(52) U.S. Cl. 381/430; 381/176; 381/423

(57) ABSTRACT

A diaphragm for a loudspeaker drive unit or for a microphone, the diaphragm including a dome-shaped member of synthetic diamond, wherein the diaphragm includes an integrally-formed, peripheral skirt. The skirt may be of cylindrical form or flared.

This invention relates to diaphragms for loudspeaker drive units or microphones. The problems addressed by the invention will be discussed in terms of loudspeaker drive units although similar problems occur in microphones.

The commonly accepted upper frequency limit for human hearing is approximately 20 kHz but it is desirable that high frequency loudspeaker drive units, commonly called “tweeters”, have a frequency response that extends, and is smooth and flat, well beyond this limit.

To a first approximation, one can consider the frequency response of a tweeter to be relatively flat until the first break-up frequency, that is, the frequency at which the tweeter stops moving as a rigid piston, that is, with all points on the surface moving with the same phase. At the break-up frequency, a peak occurs in the frequency response and the peak can be large for materials with low damping (which usually happen also to be desirable, stiff materials). Beyond the first break-up frequency a series of peaks and dips are apparent in the frequency response.

Though resonance peaks in the frequency response in stiff, low damped materials are usually of high Q and are centered on a well defined frequency, the leading edge of the resonance can ‘reach down’ by two or more octaves below the resonant peak. Thus, for instance, a break-up frequency occurring at 30 kHz, can result in performance degradation at 7.5 kHz and below. For this reason it is desirable to have break-up frequencies as high as possible, preferably beyond 80 kHz and more.

A second reason for having the first break-up frequency as high as possible, and thus a flat response to as high a frequency as possible, arises from the advent of super audio formats with bandwidths beyond the 22 kHz of the ordinary compact disc, effectively up to 96 kHz. If large peaks occur in the frequency response, the inherent non-linearity of the tweeter (arising from primarily the motor system and suspension) will be greatly increased, owing to the relatively high voice-coil displacement, and thus signals with more than one frequency component will provoke inter-modulation distortion, which will result in spurious signals at many frequencies, including the directly audible, sub 20 kHz range.

To keep the break-up frequency high, the diaphragm of the tweeter should have a very high stiffness to mass ratio, and, to make the tweeter sensitive, the diaphragm should be light. For these reasons, the use of various special materials has been proposed for tweeter diaphragms.

German patent specification DE 100 49 744 discloses making the diaphragm of a loudspeaker drive unit from polycrystalline diamond. Diamond is an excellent material to use as regards its stiffness to mass ratio but has severe drawbacks in terms of being very expensive and difficult to form. Whilst a tweeter diaphragm can be made in aluminum very easily and cheaply, to attempt to make in diamond what can be made in aluminum will certainly be enormously more expensive if, indeed, it is even possible because of the constraints of diamond technology. Plasma deposition onto a substrate (afterwards removed) is one known technique for forming a diaphragm of synthetic diamond but some shapes are impossible to make by that technique and the size of the diaphragms is constrained in large volume production by considerations of economy given that the larger the diaphragm, the fewer can be accommodated in a reactor of given size.

Thus, economic considerations and technical difficulties point towards the use of small sizes and very simple shapes for diaphragms of synthetic diamond.

A tweeter with a diamond diaphragm has been marketed commercially, the diaphragm being in the form of a simple concave dish of 19 millimetres diameter. That commercial tweeter has a break up frequency of about 70 kHz. If, other factors being equal, the dish were made larger, then the break-up frequency would fall which would, of course, be undesirable.

On the other hand, it would be desirable to make the diaphragm larger to allow more electrical power to be fed into the tweeter without causing overheating or burn-out. The factors of worsened break-up frequency and the economics and difficulty of manufacture are, however, against making such a change.

It is an object of the invention to provide a diaphragm of synthetic diamond which when used in a loudspeaker drive unit enables larger power handling to be achieved without worsening the break-up frequency.

The present invention provides a diaphragm for a loudspeaker drive unit or for a microphone, the diaphragm comprising a dome-shaped member of synthetic diamond, wherein the diaphragm includes an integrally-formed, peripheral skirt.

The provision of the integrally-formed skirt has the unexpected effect of enabling a dramatic improvement of the break-up frequency of the diaphragm to be achieved and it is, moreover, possible and economic to form such a skirt with available synthetic diamond technology. Thus, for a given break-up frequency, the diaphragm can be made bigger and so have a larger power handling capacity when used in a loudspeaker drive unit.

The skirt may be of cylindrical form. A cylindrical skirt has the advantage of proving a convenient peripheral surface to which the coil former can be adhesively secured. Instead, the skirt may, for example, be flared. Each side of the skirt may have a flare of 30 degrees or less, preferably, 20 degrees or less, more preferably between 5 and 10 degrees with respect to the central axis of the diaphragm. The use of a flared skirt can further facilitate the attachment of a voice coil former to the diaphragm by providing a gap for the entry of adhesive.

Advantageously, an integral extension of the peripheral skirt constitutes the former for a voice coil. Such an arrangement avoids the need to secure the voice coil former and diaphragm to one another. In order to have sufficient length for the voice coil, the peripheral skirt may have a depth of 4 millimetres or more, preferably approximately 5 millimetres.

Preferably, the skirt has depth of at least 0.15 millimetres preferably at least 0.3 millimetres. Such a dimension provides substantial improvement in the break-up frequency of the diaphragm.

The skirt may have a depth less than 1.0 millimetres. The value of the skirt in improving break-up frequency is greatest below 1.0 millimetres.

Particularly good result can be achieved, if the skirt has a depth between 0.5 and 0.8 millimetres inclusive.

The diaphragm may be substantially circular in front elevation. It is also possible to apply the invention to an elliptical diaphragm.

Particularly good power handling in a loudspeaker drive unit, break-up frequency and economy of manufacture can be achieved if the diaphragm has a diameter of 18 to 34 millimetres inclusive, preferably 22 to 30 millimetres inclusive, and more preferably a diameter of approximately 26 millimetres.

The diaphragm may be of substantially constant radius of curvature. Such a configuration simplifies manufacture.

Advantageously, however, the radius of curvature of the diaphragm increases towards the center of the diaphragm. Such a configuration is more difficult to make but allows a further improvement in break-up frequency to be made.

In particular, good results can be achieved when the radius of curvature of the diaphragm at its periphery is less than half the radius of curvature at the center of the diaphragm.

Preferably, the radius of the diaphragm at its center is between 16 millimetres and 24 millimetres inclusive, more preferably between 18 and 22 millimetres inclusive.

The skirt may be of substantially the same thickness or less thickness than the domed part of the diaphragm. That feature simplifies manufacture of the skirt in synthetic diamond.

Advantageously, the skirt is of substantially greater thickness than the domed part of the diaphragm. This feature is of benefit in improving the break-up frequency.

The skirt may be between 1.5 and 2.5 times, inclusive, as thick as the domed part of the diaphragm, and is preferably approximately twice as thick.

The domed part of the diaphragm may have a thickness between 0.010 and 0.1 millimetres inclusive, between 0.025 and 0.035 millimetres inclusive, preferably approximately 0.03 millimetres, or between 0.035 and 0.045 millimetres inclusive, preferably approximately 0.04 millimetres.

Advantageously, the domed part of the diaphragm has greater thickness at its periphery than at its center. This feature is again of benefit in improving the break-up frequency.

The invention also provides a loudspeaker drive unit or microphone including a diaphragm as defined above.

The invention also provides a loudspeaker drive unit comprising:
a mounting;
a diaphragm according to the invention as defined above;
a flexible surround connecting the diaphragm to the mounting;
a voice coil assembly comprising a voice coil and a former attached to the diaphragm; and
a magnet assembly surrounding the voice coil.

A loudspeaker drive unit including a diaphragm in accordance with the invention will now be described, by way of example only, with reference to the accompanying drawings, in which:

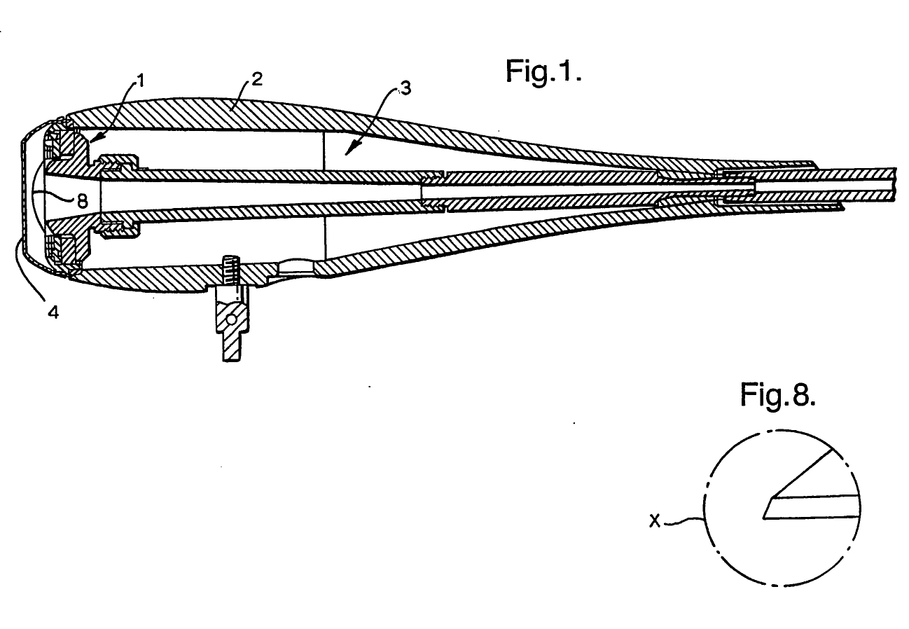

FIG. 1 is a cross-section through a loudspeaker drive unit including a diaphragm in accordance with the invention mounted in an enclosure of known form;

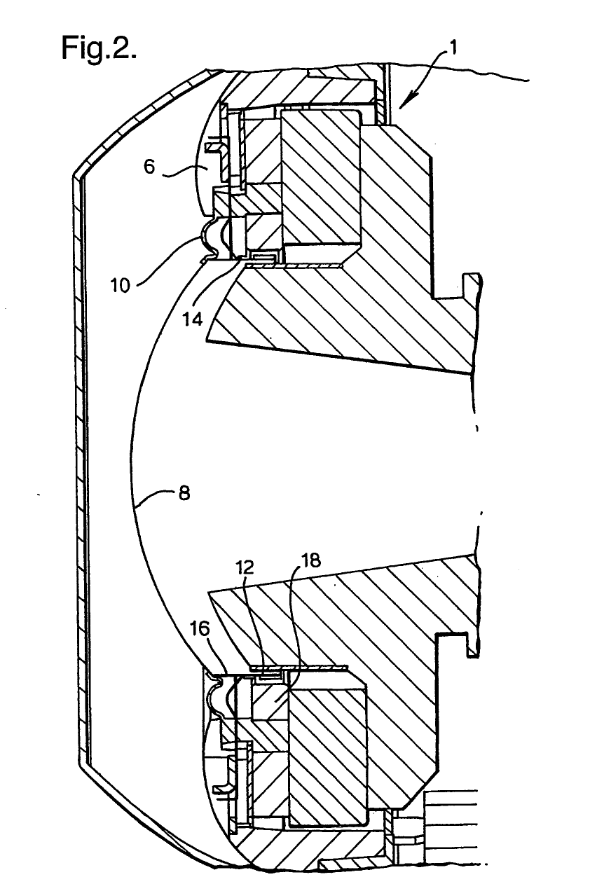

FIG. 2 is a fragment of FIG. 2 shown to an enlarged scale;

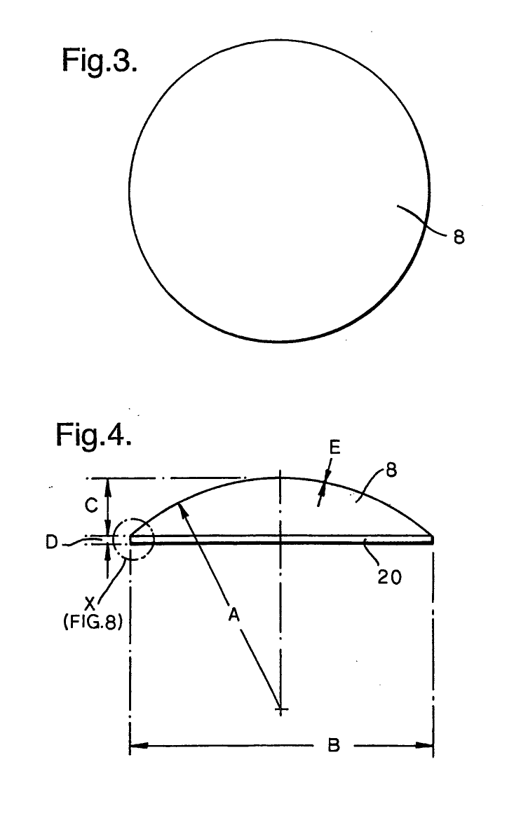

FIG. 3 is a front elevational view of the diaphragm of the loudspeaker drive unit;

FIG. 4 is a side elevational view of the diaphragm of FIG. 3;

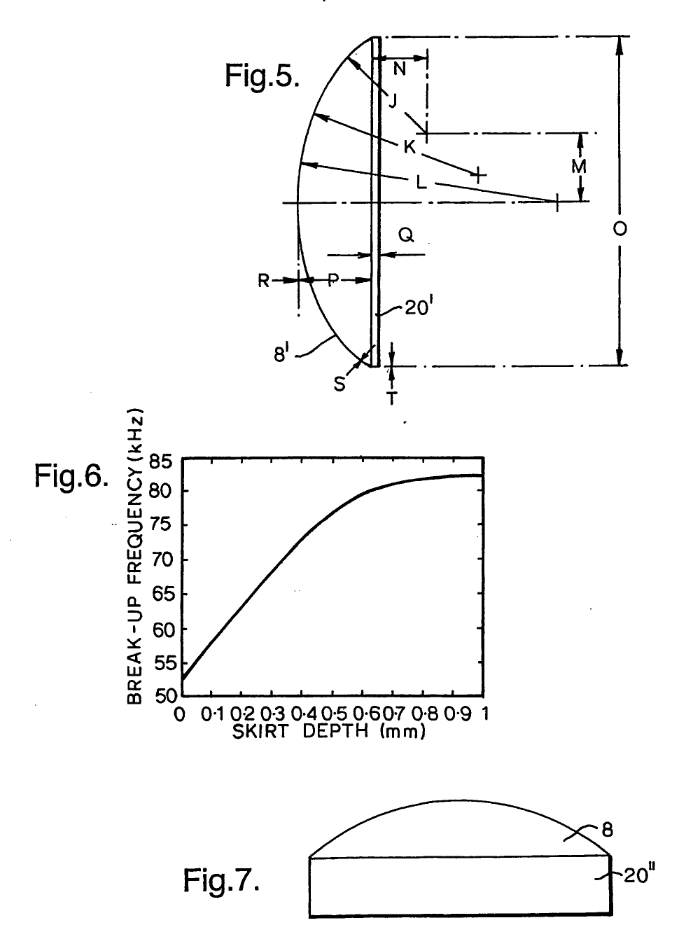

FIG. 5 is a side elevational view of a first modified diaphragm;

FIG. 6 is a graph of break-up frequency plotted against skirt depth;

FIG. 7 is a side elevational view of a second modified diaphragm; and

FIG. 8 is an enlarged view corresponding to the circle marked “X” in FIG. 4 showing a modification to the diaphragm of FIGS. 3 and 4.

Referring to the accompanying drawings, a tweeter loudspeaker drive unit 1 is mounted in an enclosure 2 and has its rear connected to a rearwardly-projecting sound absorbing tube system 3. A grill 4 is provided at the front of the enclosure 2. The enclosure 2, tube system 3 and grill 4 do not form a part of the invention and will not therefore be described further.

The loudspeaker drive unit 1 comprises a mounting plate 6, a dome-shaped diaphragm 8 of synthetic polycrystalline diamond, and a flexible surround 10 connecting the diaphragm to the mounting 6. A voice coil assembly 12 comprises a voice coil 14 and a former 16 attached to the diaphragm 8. A magnet assembly 18 surrounds the voice coil. The general configuration and mounting of the parts 6, 12, 14 16 and 18 is known and will not be described further.

According to the invention, however, the diaphragm 8 of polycrystalline diamond includes an integrally-formed, peripheral skirt 20 (see FIG. 4). The diaphragm 8 is substantially circular in front elevation (see FIG. 3) and the skirt 20 is of cylindrical form. The diamond material is of generally uniform thickness throughout the diaphragm 8 and skirt 20 and the radius of curvature of the dome is constant.

A practical example of the diaphragm shown in FIGS. 3 and 4 had dimensions according to the following table:

| Dimension marked in FIG. 4 | Millimetres |
|---|---|
| Radius A (to outer surface) | 20.00 |
| Diameter B (outside measurement) | 26.37 |
| Dome depth C | 4.96 |
| Skirt depth D | 0.65 |
| Thickness of diamond E | 0.040 |

Although the thickness of the diamond is shown in the table as nominally 0.040 millimetres, tolerance on the thickness is in the range 0.033 to 0.046 millimetres.

FIG. 5 shows a modified diaphragm 8′ with integral skirt 20′ which differs from the diaphragm 8 of FIGS. 3 and 4 in details which will now be explained. The radius of curvature of the diaphragm 8′ increases towards the center of the diaphragm and at its periphery is less than half the radius of curvature at the center of the diaphragm. The skirt 20′ is of substantially greater thickness than the domed part of the diaphragm 8′, in particular approximately twice as thick. These changes enable the break-up frequency of the diaphragm to be substantially increased.

A practical example of the diaphragm shown in FIG. 5 had dimensions according to the following table:

| Dimension marked in FIG. 5 | Millimetres |
|---|---|
| Radius J (to inside face) at periphery | 8.858 |
| Radius K (to inside face) between centre | 14.13 |
| and periphery | |
| Radius L (to inside face) at centre | 20.93 |
| Datum reference M for radius J | 5.457 |
| Second datum reference N for radius J | 4.443 |
| Diameter O (inside measurement) | 26.240 |
| Dome depth P | 5.908 |
| Skirt depth Q | 0.650 |
| Thickness of diamond R at centre | 0.030 |
| Thickness of diamond S at periphery | 0.030 |
| Thickness of diamond T in skirt | 0.070 |

Although the thickness of the diamond in the skirt is shown in the table as 0.070 millimetres, any value in the range 0.06 to 0.08 millimetres inclusive would be suitable to use in combination with the other dimensions in the table. A similar tolerance is provided on the domed part of the diaphragm

FIG. 6 is a graph showing the change in break-up frequency against skirt depth in for the diaphragm of FIGS. 3 and 4. It is to be seen that, initially, the skirt is of increasing benefit as it is made deeper but beyond a skirt depth of about 0.8 millimetres, the improvement in break-up frequency for a given increase in skirt depth becomes relatives minor.

Nevertheless, the skirt can be made considerably deeper to serve as a coil former and this can be of benefit in heat dissipation, diamond being a good conductor of heat. The skirt is given an appreciable depth as shown in FIG. 7, where the extended skirt is referenced 20″ and the diaphragm 8″, and used as former to carry the voice coil. Approximately 5 millimetres is a suitable depth for the skirt to form an integral coil former.

FIG. 8 illustrates the use of a flared skirt instead of a cylindrical skirt. The preferred degree of flare is between 5 and 10 degrees on each side as seen in cross-section with respect to the central axis, that is, the overall flare of the skirt is between 10 and 20 degrees.

Many variations to the described embodiments can be made without departing from the scope of the appended claims. For example, the domed part of the diaphragm can have a greater thickness at its periphery (S) than at its center (R). Such a variation in material thickness in the dome also serves to increase the break-up frequency of the diaphragm and can, if desired, be combined with a varying radius of curvature for the dome.

The diaphragm of a loudspeaker drive unit according to the invention can be mounted with its convex face forwards, or reversed so that its concave face is to the front.

1-24. (canceled)

25. A diaphragm for a loudspeaker drive unit or for a microphone, the diaphragm comprising a dome-shaped member of synthetic diamond, wherein the diaphragm includes an integrally-formed, peripheral skirt.

26. A diaphragm as claimed in claim 25, wherein the skirt is selected from the group consisting of a skirt of cylindrical form, and a flared skirt.

27. A diaphragm as claimed in claim 26, wherein each side of the skirt has a flare selected from the group consisting of a flare of 30 degrees or less, a flare of 20 degrees or less, and a flare of between 5 and 10 degrees with respect to the central axis of the diaphragm.

28. A diaphragm as claimed in claim 25, wherein an integral extension of the peripheral skirt constitutes the former for a voice coil.

29. A diaphragm as claimed in claim 28, wherein the peripheral skirt has a depth selected from the group consisting of a depth of 4 millimetres or more,
approximately 5 millimetres,
at least 0.15 millimetres, at least 0.3 millimetres,
less than 1.0 millimetres, and
between 0.5 and 0.8 millimetres, inclusive.

30. A diaphragm as claimed in claim 25, wherein the diaphragm is substantially circular in front elevation.

31. A diaphragm as claimed in claim 25, wherein the diaphragm has a diameter selected from the group consisting of between 18 and 34 millimetres inclusive, between 22 and 30 millimetres inclusive, and approximately 26 millimetres.

32. A diaphragm as claimed in claim 25, wherein the diaphragm has a curvature selected from the group consisting of a substantially constant radius of curvature, a radius of curvature of the diaphragm increasing towards the center of the diaphragm, a radius of curvature of the diaphragm at its periphery less than half the radius of curvature at the center of the diaphragm, and a radius of the diaphragm at its center is selected from the group consisting of between 16 millimetres and 24 millimetres inclusive, and between 18 and 22 millimetres, inclusive.

33. A diaphragm as claimed in claim 25, wherein the skirt thickness is selected from the group consisting of:
substantially the same thickness or less than the domed part of the diaphragm,
of substantially greater thickness than the domed part of the diaphragm,
a skirt thickness between 1.5 and 2.5 times, inclusive,
as thick as the domed part of the diaphragm, and
skirt thickness approximately twice as thick as the domed part of the diaphragm.

34. A diaphragm as claimed in claim 25, wherein the domed part of the diaphragm has a thickness selected from the group consisting of between 0.010 and 0.1 millimetres inclusive, between 0.025 and 0.035 millimetres inclusive, approximately 0.03 millimetres, between 0.035 and 0.045 millimetres inclusive, approximately 0.04 millimetres, and a greater thickness at the periphery of the domed part of the diaphragm than at its center.

35. A loudspeaker drive unit or microphone including the diaphragm as claimed in claim 25.

36. A loudspeaker drive unit comprising:
a mounting;
a diaphragm a flexible surround connecting the diaphragm to the mounting;
a voice coil assembly comprising a voice coil and a former attached to the diaphragm; and
a magnet assembly surrounding the voice coil, wherein the said diaphragm comprises a dome-shaped member of synthetic diamond, wherein the diaphragm includes an integrally-formed, peripheral skirt and the diaphragm has a diameter of between 22 and 34 millimetres inclusive.

37. A loudspeaker drive unit as claimed in claim 36, wherein the domed part of the said diaphragm has a thickness of between 0.025 and 0.045 millimetres inclusive.

38. A loudspeaker drive unit as claimed in claim 36, wherein the peripheral skirt has a depth less than 1.0 millimetres.

39. A loudspeaker drive unit as claimed in claim 36, wherein the skirt is flared.

40. A loudspeaker drive unit as claimed in claim 36, wherein the said diaphragm has a substantially constant radius of curvature of between 18 and 24 millimetres inclusive.

41. A loudspeaker drive unit comprising:
a mounting;
a diaphragm;
a flexible surround connecting the diaphragm to the mounting;
a voice coil assembly comprising a voice coil and a former attached to the diaphragm; and
a magnet assembly surrounding the voice coil, wherein the diaphragm comprising a dome-shaped member of synthetic diamond, wherein the said diaphragm includes an integrally-formed, peripheral skirt and the said peripheral skirt has a depth of at least 0.3 millimetres and less than 1.0 millimetres.

42. A loudspeaker drive unit as claimed in claim 41, wherein the said peripheral skirt has a depth between 0.5 and 0.8 millimetres inclusive.

43. A loudspeaker drive unit as claimed in claim 41, wherein the said diaphragm has a diameter of between 22 and 34 millimetres inclusive.

44. A loudspeaker drive unit as claimed in claim 41, wherein the domed part of the said diaphragm has a thickness of between 0.025 and 0.045 millimetres inclusive.

45. A loudspeaker drive unit as claimed in claim 41, wherein the skirt is flared.
